(19) United States
(12) Patent Application Publication
(10) Pub. No.: US 2026/0361483 A1
(43) Pub. Date: Nov. 12, 2026

(54) TECHNIQUES FOR SYNCHRONIZATION SIGNAL BLOCK (SSB) TRANSMISSION ON A MULTI-RAT SPECTRUM SHARING (MRSS) CARRIER

(71) Applicant: Apple Inc., Cupertino, CA (US)

(72) Inventors: Wanlu SUN, San Diego, CA (US); Haitong SUN, Cupertino, CA (US); Hong HE, San Jose, CA (US); Laxminarayana PILLUTLA, San Diego, CA (US); Seung Hee HAN, San Jose, CA (US); Sharad SAMBHWANI, San Diego, CA (US); Sigen YE, San Diego, CA (US); Srinivasan BALASUBRAMANIAN, San Diego, CA (US); Vishnusudhan RAGHUPATHY, Escondido, CA (US); Wei ZENG, Saratoga, CA (US); Xipeng ZHU, San Diego, CA (US); Yang TANG, San Jose, CA (US)

(21) Appl. No.: 19/640,708

(22) Filed: Apr. 7, 2026

Related U.S. Application Data
(60) Provisional application No. 63/802,441, filed on May 8, 2025.

(51) Int. Cl. H04L 5/00; H04W 16/14; H04W 24/08

(52) U.S. Cl. CPC H04L 5/0048; H04W 16/14; H04W 24/08

(57) ABSTRACT

Embodiments regard techniques for synchronization signal block (SSB) transmission on a multiple radio access technology (multi-RAT) spectrum sharing (MRSS) carrier. Next generation, e.g., sixth generation (6G), wireless devices are expected to share some radio frequency (RF) bands with previous generation, e.g., fifth generation (5G), wireless devices, and various SSB designs can support efficient transmission of different generation SSBs on an MRSS carrier. An SSB configured for a first radio access technology (RAT) can reuse aspects of an SSB configured for a second RAT with some modifications. An SSB configured for the first RAT can differ substantially from an SSB configured for a second RAT, such as using different PSS/SSS sequences. A wireless device configured for a first RAT can perform supplemental reference signal (RS) measurement of a radio channel using a portion of an SSB configured for a second RAT.

### CROSS-REFERENCE TO RELATED APPLICATIONS

The present application claims the benefit of U.S. Provisional Application No. 63/802,441, entitled “TECHNIQUES FOR SYNCHRONIZATION SIGNAL BLOCK (SSB) TRANSMISSION ON A MULTI-RAT SPECTRUM SHARING (MRSS) CARRIER,” filed May 8, 2025, the content of which is incorporated by reference herein in its entirety for all purposes.

### FIELD

The described embodiments relate to wireless communications, including techniques for synchronization signal block (SSB) transmission on a multiple radio access technology (multi-RAT) spectrum sharing (MRSS) carrier. Next generation, e.g., sixth generation (6G), wireless devices are expected to share some radio frequency (RF) bands with previous generation, e.g., fifth generation (5G), wireless devices, and various SSB designs for a next generation wireless communication protocol can support efficient SSB transmission for both previous generation SSB, e.g., 5G SSB, and next generation SSB, e.g., 6G SSB, on an MRSS carrier.

### BACKGROUND

Newer generation, fifth generation (5G), cellular wireless networks that implement one or more 3^{rd} Generation Partnership Project (3GPP) standards are rapidly being developed and deployed by mobile network operators (MNOs) worldwide. In addition, sixth generation (6G) standards are in active development. The newer cellular wireless networks provide a range of packet-based services, with 5G (and 6G) technology providing increased data throughput and lower latency connections that promise enhanced mobile broadband services for 5G-capable (and 6G-capable) wireless devices. Access to cellular services provided by an MNO can require use to cellular credentials and/or secure processing provided by a secure element (SE), such as a universal integrated circuit card (UICC), an embedded UICC (eUICC), or an integrated UICC (iUICC) included in the wireless device.

Limited new radio frequency (RF) spectrum for exclusive 6G use is expected to be available in key 6G markets, especially for lower RF bands. As with previous successive generations of wireless communication standards, newer 6G wireless infrastructure and 6G wireless devices will be gradually deployed and coexist with older, e.g., 5G, wireless infrastructure and wireless devices. Sharing RF spectrum between 6G and 5G wireless devices can provide for coverage (range) extension of higher RF bands. Dynamic spectrum sharing between 5G and 6G is referred to as multiple radio access technology (multi-RAT) spectrum sharing (MRSS) and is expected to be standardized by 3GPP and used with initial 6G deployments.

A significant portion of overhead in cellular wireless communication can be attributed to synchronization signal block (SSB) transmission. To realize efficiency and reduce power consumption for wireless communication via an MRSS carrier shared by both 5G and 6G technology, mechanisms are need to provide efficient designs for new 6G SSB in view of current 5G SSB.

### SUMMARY

The described embodiments relate to wireless communications, including techniques for synchronization signal block (SSB) transmission on a multiple radio access technology (multi-RAT) spectrum sharing (MRSS) carrier. Next generation, e.g., sixth generation (6G), wireless devices are expected to share some radio frequency (RF) bands with previous generation, e.g., fifth generation (5G), wireless devices, and various next generation SSB, e.g., 6G SSB, designs can support efficient SSB transmission for both previous generation SSB and next generation SSB, e.g., 5G SSB and 6G SSB, on an MRSS carrier. In some embodiments, a next generation SSB, e.g., 6G SSB, reuses aspects of a previous generation, e.g., 5G SSB, with some modifications, such as a same/similar primary synchronization sequence (PSS) and secondary synchronization sequence (SSS) with changes to periodicity and/or enablement/disablement of the next generation SSB, e.g., the 6G SSB. In some embodiments, a next generation SSB, e.g., 6G SSB, differs substantially from a previous generation SSB, e.g., a 5G SSB, such as using different PSS/SSS sequences. While the ideas discussed herein are presented via an MRSS carrier that combines 5G and 6G transmissions, the use of 5G and 6G should not be considered as limiting, and the same or similar ideas can be applied to an MRSS carrier that mixes two (or more) generations of wireless communication protocol transmissions, e.g., a carrier used by both a first RAT and a second RAT. An SSB configured for a first radio access technology (RAT) can reuse aspects of an SSB configured for a second RAT with some modifications. An SSB configured for the first RAT can differ substantially from an SSB configured for a second RAT, such as using different PSS/SSS sequences. A wireless device configured for a first RAT can perform supplemental reference signal (RS) measurement of a radio channel using a portion of an SSB configured for a second RAT.

Several solutions to provide efficient SSB transmission on an MRSS carrier, e.g., a 5G/6G MRSS carrier, corresponding to different designs for 6G SSBs are provided. In some embodiments, 5G SSB transmissions and 5G SSB transmission are completely distinct, e.g., using different time-frequency resources, orthogonally separable, and/or spatially separate. In some embodiments, 6G PSS sequences differ from 5G PSS sequences, e.g., based on a different M-sequence polynomial used to generate the 6G PSS or a same M-sequence polynomial sued to generate the 5G PSS with a different cyclic shift values. In some embodiments, a 6G SSB transmitted on a 5G/6G MRSS carrier includes a reduced version of a 6G SSB transmitted on a 6G only carrier. In some embodiments, a 6G wireless device receives, from a cellular wireless radio access network (RAN) entity, configuration information for at least a portion of a 5G SSB transmitted via a 5G/6G MRSS carrier, where the 6G wireless device uses the portion of the 5G SSB as an additional measurement reference signal (RS) to supplement a 6G SSB transmitted via the 5G/6G MRSS carrier. In some embodiments, a cellular wireless RAN entity provides to a 6G UE quasi-colocation (QCL) indications, antenna port indications, and/or power offset indications between 6G SSBs, used as primary SSBs for the 6G UE, and 5G SSBs (or portions thereof), used as secondary SSBs for the 6G UE. In some embodiments, 6G SSB partially shares time-frequency resources with a 5G SSB. In some embodiments, a 6G SSB reuses a 5G SSB with minor modifications, such as using a subset or superset of 5G SSBs.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to adapt communication parameters for a wireless device, according to some embodiments.

FIG. 2 illustrates a block diagram of a more detailed view of exemplary components of a wireless device of the system of FIG. 1, according to some embodiments.

FIG. 3 illustrates a block diagram of an exemplary system for sharing select radio frequency bands between wireless devices using different generations of wireless cellular communication protocols, according to some embodiments.

FIG. 4 illustrates a block diagram of an exemplary fifth generation (5G) synchronization signal block (SSB), according to some embodiments.

FIG. 5A illustrates an example of distinct 5G SSB transmissions and sixth generation (6G) SSB transmissions using different time-frequency resources, according to some embodiments.

FIG. 5B illustrates an example of 5G physical downlink shared channel (PDSCH) transmissions and 6G PDSCH transmissions rate matching around 5G SSBs and 6G SSBs, according to some embodiments.

FIG. 5C illustrates exemplary SSBs on different types of 5G and 6G channels, according to some embodiments.

FIG. 5D illustrates a flow chart of an example of secondary SSB use by a 6G wireless device, according to some embodiments.

FIG. 6 illustrates an example of 5G SSB bursts and 6G SSB bursts with beam forming.

FIGS. 7A and 7B illustrate exemplary structures to share time-frequency resources for a 5G SSB and a 5G 6SB on an MRSS carrier, according to some embodiments.

FIG. 8A illustrates a flow chart of an exemplary method to use a secondary SSB for supplemental measurement by one or more components of a 6G wireless device, according to some embodiments.

FIG. 8B illustrates a flow chart of an exemplary method to distinguish SSBs of two different radio access technologies (RATs), according to some embodiments.

FIG. 9 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

The described embodiments relate to wireless communications, including techniques for synchronization signal block (SSB) transmission on a multiple radio access technology (multi-RAT) spectrum sharing (MRSS) carrier. Next generation, e.g., sixth generation (6G), wireless devices are expected to share some radio frequency (RF) bands with previous generation, e.g., fifth generation (5G), wireless devices, and various next generation SSB, e.g., 6G SSB, designs can support efficient previous generation SSB, e.g., 5G SSB, and next generation, e.g., 6G SSB, transmission on an MRSS carrier. In some embodiments, a next generation SSB, e.g., 6G SSB, reuses aspects of a previous generation SSB, e.g., 5G SSB, with some modifications, such as a same/similar primary synchronization sequence (PSS) and secondary synchronization sequence (SSS) with changes to periodicity and/or enablement/disablement of a next generation SSB, e.g., 6G SSB. In some embodiments, a next generation SSB, e.g., 6G SSB, differs substantially from a previous generation SSB, e.g., 5G SSB, such as using different PSS/SSS sequences. While the ideas discussed herein are presented via an MRSS carrier that combines 5G and 6G transmissions, the use of 5G and 6G should not be considered as limiting, and the same or similar ideas can be applied to an MRSS carrier that mixes two (or more) generations of wireless communication protocol transmissions, e.g., a carrier used by both a first RAT and a second RAT. An SSB configured for a first radio access technology (RAT) can reuse aspects of an SSB configured for a second RAT with some modifications. An SSB configured for the first RAT can differ substantially from an SSB configured for a second RAT, such as using different PSS/SSS sequences. A wireless device configured for a first RAT can perform supplemental reference signal (RS) measurement of a radio channel using a portion of an SSB configured for a second RAT.

Several mechanisms are discussed herein to enable efficient SSB transmission on an MRSS carrier. In a first mechanism, 5G SSB and 6G SSB transmissions are separate and distinguishable. In a one option, a 5G PSS sequence for a 5G SSB and a 6G PSS sequence for a 6G SSB are distinct. In some embodiments, an M-sequence for a 6G PSS is generated by the polynomial x\hat{ }7+x\hat{ }1+1, which is a preferred pair of the polynomial used to generate the M-sequence for the 5G PSS of the 5G SSB. In some embodiments, an M-sequence for a 6G PSS is generated with the same polynomial used for the M-sequence for the 5G PSS with different cyclic shift values applied to the 6G PSS than used for the 5G PSS. In some embodiments, a 6G physical downlink shared channel (PDSH) rate matches around 5G SSBs. In a second mechanism, a secondary 6G SSB is configured based on a 5G SSB (or a portion thereof) to be used by a 6G wireless device as an additional measurement reference signal (RS) when operating on a 5G/6G shared MRSS carrier. A 6G radio access network (RAN) entity can provide configuration information for the secondary 6G SSB to the 6G wireless device. In some embodiments, the 6G RAN provides to a 6G wireless device one or more of: i) quasi-colocation (QCL) indications, ii) antenna port indications, or power offset indications between a primary 6G SSB and the secondary 6G SSB (which is a 5G SSB or portion thereof). In a third mechanism, a 5G SSB and a 6G SSB are distinct SSBs that share (overlap) at least in part time-frequency resources but are still separable from each other by 5G wireless devices and 6G wireless devices. In a fourth mechanism, a 5G SSB and a 6G SSB use common SSBs with some modifications, such as changes in periodicity, for a 6G SSB.

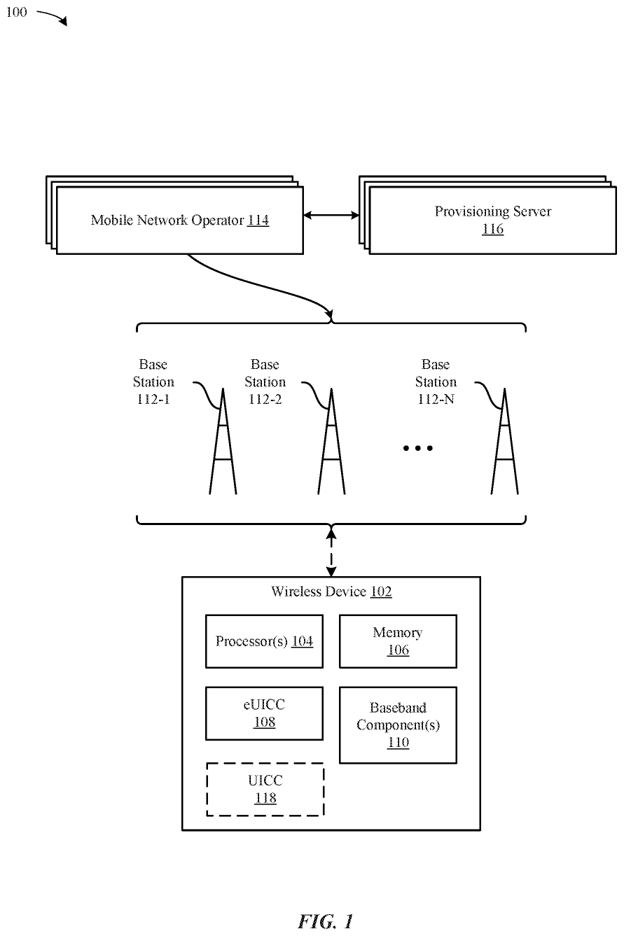

These and other embodiments are discussed below with reference to FIGS. 1 through 9; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 112-1 to 112-N, which are managed by different Mobile Network Operators (MNOs) 114, and iii) a set of provisioning servers 116 that are in communication with the MNOs 114. The wireless device 102 can represent a mobile computing device (e.g., a phone, a tablet, a peripheral device, etc.), the base stations 112-1 to 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUs)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and baseband component 110 used for transmission and reception of cellular wireless radio frequency signals. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIM (eSIM) profiles and/or an iUICC providing one or more eSIM profiles. A wireless device 102 that includes multiple active (enabled) SIMs and/or eSIM profiles can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, baseband component 110, and UICC 118) can be arranged and combined in any number of configurations.

The eUICC 108 can be configured to store multiple eSIM profiles for accessing services offered by one or more different MNOs 114 via communication through base stations 112-1 to 112-N. To be able to access services provided by the MNOs, one or more eSIM profiles can be provisioned to the eUICC 108 of the wireless device 102. The wireless device 102 can include wireless circuitry, including the baseband component 110 and at least one transmitter/receiver, also referred to as a transceiver to transmit to and receive cellular wireless signals from network access network entities of a cellular wireless network.

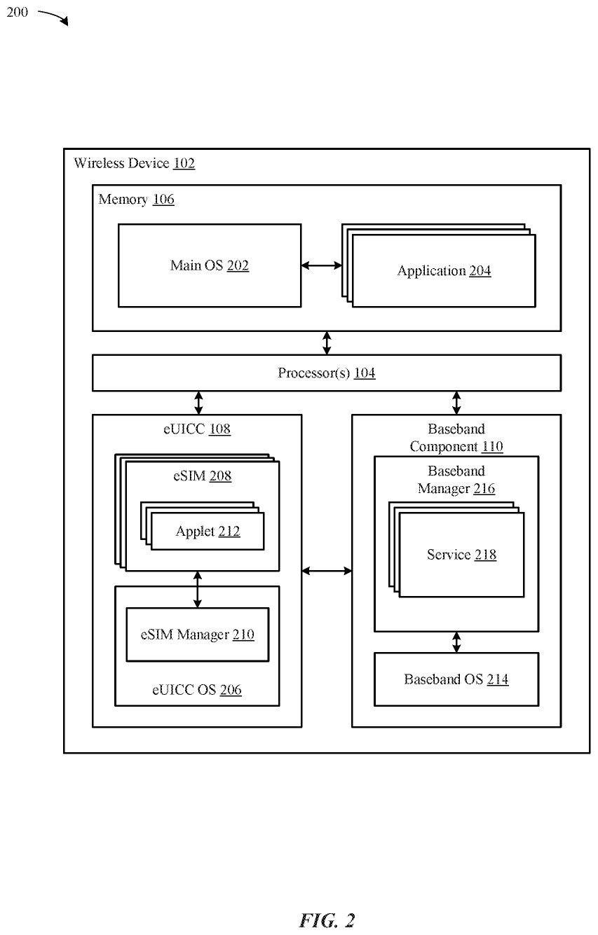

FIG. 2 illustrates a block diagram 200 of a more detailed view of exemplary components of a wireless device 102 of the system 100 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states, activity/inactivity states. The wireless device 102 further includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIM 208 profiles within the eUICC 108 and providing the baseband component 110 with access to the eSIM 208 profiles to provide access to wireless services for the wireless device 102. The eUICC OS 206 can include an eSIM manager 210, which can perform management functions for various eSIM 208 profiles. Each eSIM 208 profile can include a number of applets 212 that define the manner in which the eSIM 208 profile operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

The baseband component 110 of the wireless device 102 can include a baseband OS 214 that is configured to manage hardware resources of the baseband component 110 (e.g., a processor, a memory, different radio components, etc.). The baseband component 110 (or a portion thereof) can also be referred to as a baseband component, a wireless baseband component, a baseband wireless processor, a cellular baseband component, a cellular component, and the like. According to some embodiments, the baseband component 110 can implement a baseband manager 216 that is configured to interface with the eUICC 108 to establish a secure channel with a provisioning server 116 and obtain information (such as eSIM 208 profile data) from the provisioning server 116 for purposes of managing eSIM 208 profiles. The baseband manager 216 can be configured to implement services 218, which represent a collection of software modules that are instantiated by way of the various applets 212 of enabled eSIM 208 profiles that are included in the eUICC 108. For example, services 218 can be configured to manage different connections between the wireless device 102 and MNOs 114 according to the different eSIMs 208 that are enabled within the eUICC 108. In some embodiments, a processor 104 of the wireless device 102 and/or the eUICC 108 can include a local profile assistance (LPA) module to assist with management of eSIM 208 profiles on the eUICC 108 of the wireless device 102.

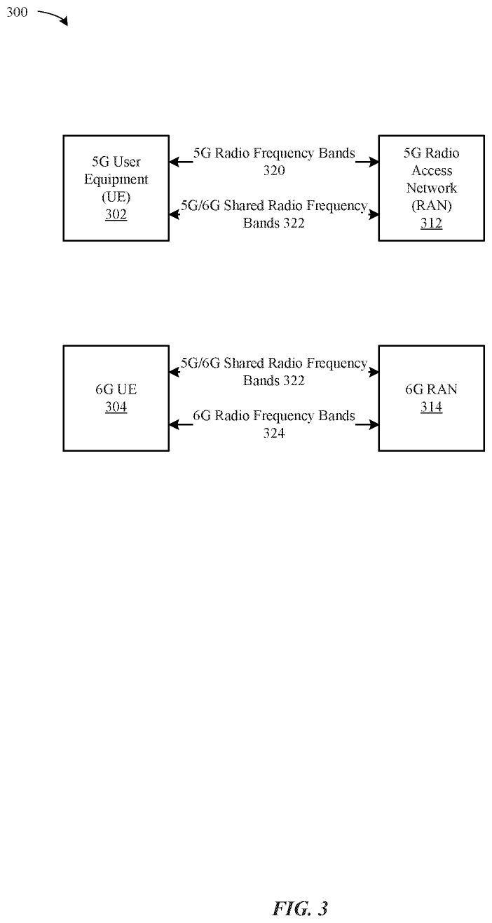

FIG. 3 illustrates a block diagram 300 of an exemplary system for sharing select radio frequency (RF) bands between wireless devices 102 that use different generations of wireless cellular communication protocols. As new RF spectrum for wireless devices 102 that operate using a standardized sixth generation (6G) cellular wireless communication protocol is expected to be limited in key 6G markets, especially for lower RF bands that have longer reach and provide coverage extension for wireless devices 102 operating in higher RF bands. In addition, to accommodate the technology transition from fifth generation (5G) to 6G, wireless devices 102 that use 6G are expected to coexist with wireless devices 102 that use 5G for an extended period of time. Static RF spectrum sharing could be used to divide various RF bands between use by 5G and 6G; however, dynamic RF spectrum sharing, referred to as multiple radio access technology (RAT) or multi-RAT spectrum sharing (MRSS) is preferred to provide more efficient RF radio resource utilization.

A 5G radio access network (RAN) 312 can be deployed as part of a cellular wireless network to provide wireless access to a 5G user equipment (UE) 302 via one or more RF carriers in one or more 5G RF bands 320 and/or in one or more 5G/6G shared RF bands 322, i.e., in one or more MRSS RF bands. The 5G UE 302 can transmit, receive, and decode radio signals in accordance with a standardized 5G cellular wireless communication protocol, including in a 5G/6G shared RF band 322. The 5G UE 302 may receive but be incapable of decoding radio signals in accordance with a standardized 6G cellular wireless communication protocol in the 5G/6G shared RF band 322.

A 6G RAN 314 can also be deployed, substantially co-located with the 5G RAN 312 in some circumstances, to provide wireless access to a 6G UE 304 via one or more RF carriers in one or more 6G RF bands 324 and/or in the one or more 5G/6G shared RF bands 322. The 6G UE 304 can transmit, received, and decode radio signals in accordance with a standardized 6G cellular wireless communication protocol, including in the 5G/6G shared RF band 322. The 6G UE 304 may receive and be capable of using select radio signals in accordance with the standardized 5G cellular wireless communication protocol as described further herein. In some embodiments, the 6G UE 304 can receive a portion of a 5G synchronization signal block (SSB) to use as a secondary SSB, supplemental to a 6G SSB, as a reference signal (RS) for RS measurements.

Fixed downlink (DL) overhead in a 5G cellular wireless communication protocol can be attributed to the 5G SSB, to system information blocks (SIBs), and to paging transmissions. A large portion of 5G DL overhead can be attributed to the 5G SSBs because of their relatively lower periodicity, e.g., transmitted every 20 ms, and to the number of repeated SSBs transmitted per SSB burst. In general, to ensure mutual compatibility between 5G UEs 302 and 6G UEs using a 5G/6G shared RF band 322, the functionality and performance of a 5G UE 302 should be minimally (if at all) affected by a 6G UE 304. To reduce complexity for a 6G UE 304, the characteristics of 6G transmissions via a 6G only carrier in a 6G RF band 324 should be comparable to transmissions via a 5G/6G MRSS carrier in a 5G/6G shared RF band 322. In some embodiments, whether a pure 6G carrier or a 5G/6G MRSS carrier is used can be transparent to a 6G UE 304.

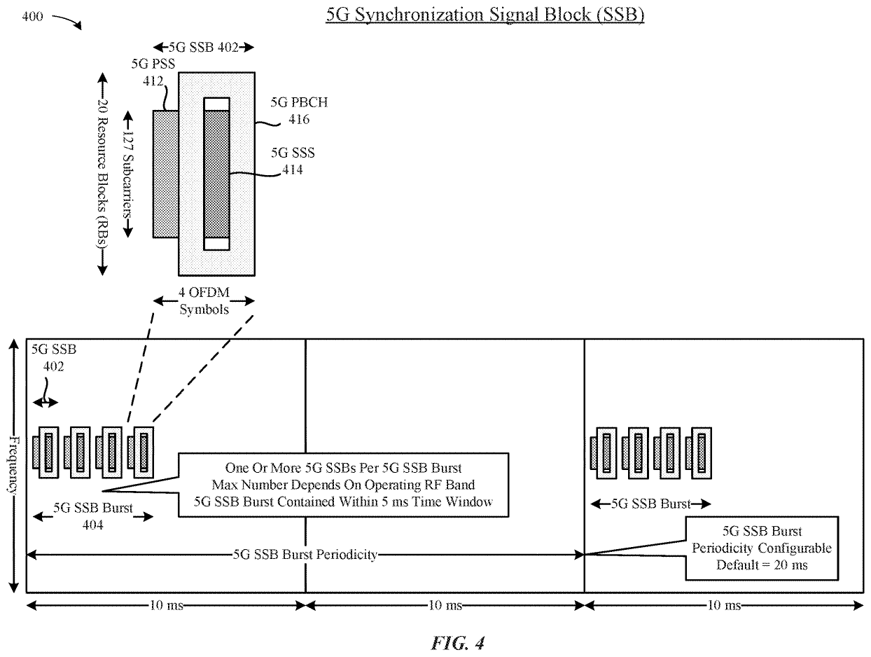

FIG. 4 illustrates a block diagram 400 of an exemplary 5G SSB 402. Including on a 5G/6G MRSS carrier, a 5G UE 302 can use 5G SSB 402 transmissions by a 5G RAN 312 to search for and synchronize with a 5G cell of the 5G RAN 312. The 5G SSB 402 is transmitted by the 5G RAN 312 periodically and includes a 5G primary synchronization signal (PSS) 412 and a 5G secondary synchronization signal (SSS) 414, each of which span 127 subcarriers in the frequency domain, and a 5G physical broadcast channel (PBCH) 416 that spans 20 resource blocks (RBs) and occupies portions of three time-adjacent orthogonal frequency division multiplexing (OFDM) symbols. The complete 5G SSB 402 spans a total of 4 consecutive OFDM symbols beginning with the 5G PSS 412 in the first OFDM symbol followed by the 5G SSS 414 in the third OFDM symbol surrounded by the 5G PBCH 416 in the second, third, and fourth OFDM symbols. The 5G PSS 412 and the 5G SSS 414 span the same set of subcarriers. A number of empty subcarriers surround the 5G SSS 414. Each 5G SSB 402 is relatively short in time and can be repeated multiple times to form a 5G SSB burst 404. The maximum number of 5G SSBs 402 per 5G SSB burst 404 can depend on an operating RF band used (higher RF bands allow for more 5G SSBs 402 per 5G SSB burst 404). For RF bands below 3 GHz, each 5G SSB burst 404 can include up to four 5G SSBs 402. For RF bands between 3 GHz and 6 GHz (e.g., FR1 bands), each 5G SSB burst 404 can include up to eight 5G SSBs 402. For even higher RF bands (e.g., FR2 bands), each 5G SSB burst 404 can include up to 64 5G SSBs 402. Each 5G SSB burst 404 can be contained within a 5 millisecond (ms) time window either in the first half of a 10 ms frame (as illustrated) or in the second half of a 10 ms frame (not shown). The 5G SSB bursts 404 are transmitted repeatedly with a 5G SSB burst periodicity that can be configurable, e.g., varying between 5 ms and 160 ms, with a default value of 20 ms. Shorter 5G SSB burst periodicities allow for faster cell search by a 5G UE 302, while longer 5G SSB burst periodicities improve network radio resource utilization (fewer radio resources user for overhead).

5G cellular wireless communication protocols support up to 1008 different physical cell identity (PCI) values indicated by sequences included in the 5G PSS 412 and the 5G SSS 414. The 5G SSB 402 includes information needed for initial access by a 5G UE 302 and also for performing radio resource management (RRM) measurements by the 5G UE 302. The 5G PBCH 416 includes a master information block (MIB) that carries information to allow the 5G UE 302 to locate additional system information blocks (SIBs) broadcast by the 5G RAN 312.

A 6G cellular wireless communication protocol can specify one or more designs for a 6G SSB that provides a similar function as the 5G SSB 402, e.g., specific synchronization signal sequences for time synchronization, a MIB, etc. In some designs, a 6G SSB can reuse aspects of a 5G SSB 402, such as the same design as the 5G SSB 402 with different (e.g., longer) periodicities, options for enabling (turning on) and disabling (turning off) the presence of a 6G SSB, etc. In some designs, a 6G SSB can different substantially in some aspects from a 5G SSB 402, e.g., different sequences used for a 6G PSS and/or a 6G SSS. As described herein, several designs are proposed for a 6G SSB on a 5G/6G MRSS carrier that enable efficient 6G SSB transmission. In some designs, separate 5G SSB 402 and 6G SSB transmissions are used for 5G UEs 302 and 6G UEs 304 on a 5G/6G MRSS carrier. In some designs, a 6G secondary SSB is configured for a 6G UE 304 to be used as a supplemental RS measurement, via a portion of a 5G SSB 402 transmitted for a 5G UE 302 via a 5G/6G MRSS carrier in addition to a 6G SSB transmitted via the 5G/6G MRSS carrier. In some designs, 5G SSB 402 and 6G SSB transmissions partially overlap in use of time-frequency resources in the 5G/6G RF band. In some designs, a 6G SSB and a 5G SSB 402 use common transmissions.

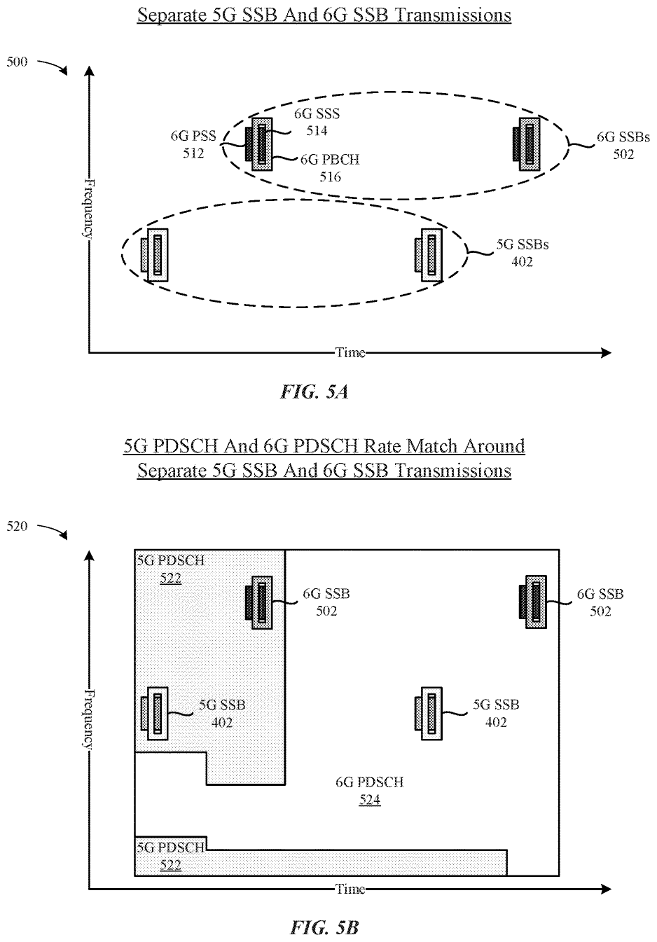

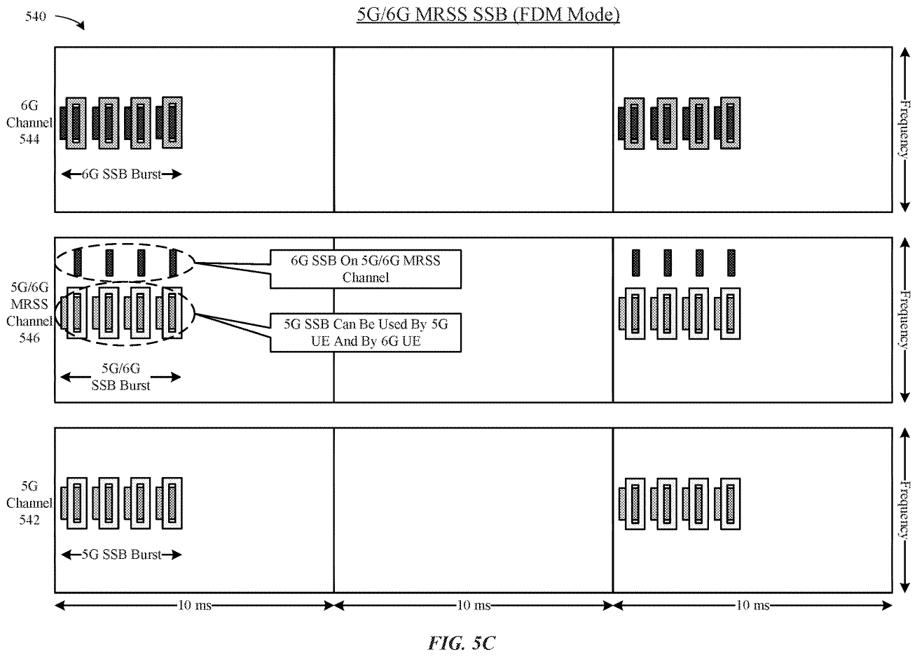

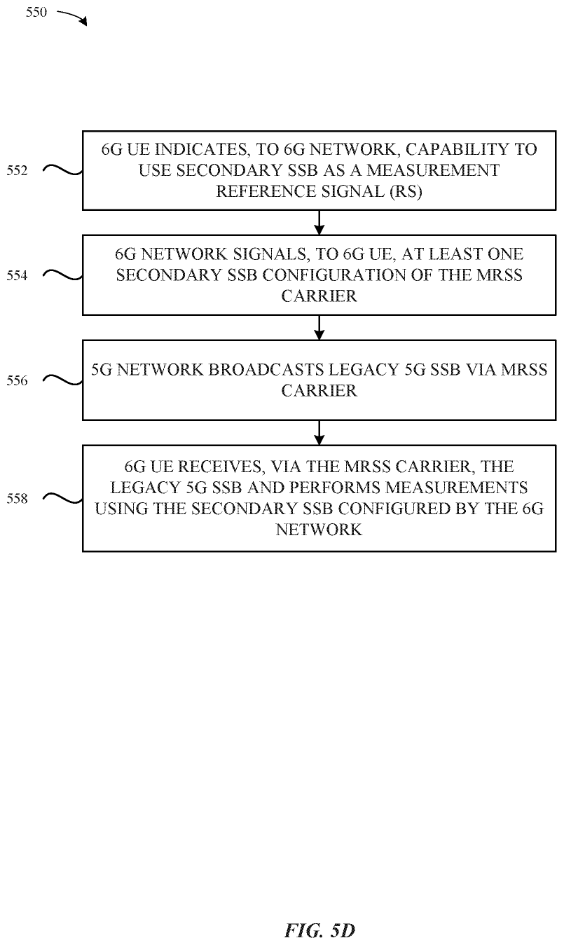

FIG. 5A illustrates a diagram 500 of an example of distinct 5G SSB 402 and 6G SSB 502 transmissions. The 5G SSB 402 and the 6G SSB 502 use distinct time-frequency resources, and the 6G SSB 502 can use the same or a different structure for assembling its constituent components, e.g., a 6G PSS 512, a 6G SSS 514, and a 6G PBCH 516 of the 6G SSB 502 can use similar or different constructs and/or arrangement of components from those used for the 5G SSB 402. For simplicity, the 6G SSB 502 is illustrated using similar blocks as the 5G SSB 402, albeit marked with different tones; however, it should assumed that any feasible structure using time-frequency resource elements to assemble a 6G SSB 502 that includes a 6G PSS 512, a 6G SSS 514, and a 6G PBCH 516 can be considered. A 6G UE 304 must be able to receive and decode a 6G SSB 502 to locate and connect to a 6G cell transmitted by a 6G RAN 314 entity that provides access to a 6G cellular wireless network, but the 6G UE 304 need not understand a 5G SSB 402 and is not expected to locate and connect to a 5G cell transmitted by a 5G RAN 312 entity. Similarly, a 5G UE 302 must be able to receive and decode a 5G SSB 402 to locate and connect to a 5G cell transmitted by a 5G RAN 312 entity that provides access to a 5G cellular wireless network, the 5G UE 302 need not understand a 6G SSB 502 and is not expected to locate and connect to a 6G cell transmitted by a 6G RAN 314 entity. Several different alternatives (or combinations thereof) are proposed herein to allow a 6G SSB 502 to be distinguishable from a 5G SSB 402.

In a first alternative, a 6G PSS 512 of a 6G SSB 502 uses a different sequence that is distinguishable from a sequence used for a 5G PSS 412 of a 5G SSB 402. In a first option, the 6G PSS 512 can include an M-sequence generated by the polynomial x\hat{ }7+x\hat{ }1+1, which is the preferred pair of the M-sequence of the 5G PSS 412, which can be generated by the polynomial x\hat{ }7+x\hat{ }4+1. In a second option, the 6G PSS 512 can an M-sequence generated by the same polynomial used to generate the 5G PSS 412 with different cyclic shift values for the 6G PSS 512 than used for the 5G PSS 412. Exemplary cyclic shift values for the 6G PSS 512 include {22, 65, 108} or {21, 64, 107}, while the cyclic shift values for the 5G PSS 412 include {0, 43, 86}.

In a second alternative, a 6G SSS 514 of a 6G SSB 502 uses a different sequence that is distinguishable from a sequence used for a 5G SSS 414 of a 5G SSB 402, for example generated by different polynomials or by using a same polynomial with different cyclic shift values. In a third alternative, a format of a 6G PBCH 516 of a 6G SSB 502 differs from a format of a 5G PBCH 416 of a 5G SSB 402.

In a fourth alternative, a demodulation reference signal (DM-RS) of a 6G PBCH 516 of a 6G SSB 502 includes one or more patterns and/or sequences that are different from the DM-RS of a 5G PBCH 416 of a 5G SSB 402. Specific resource elements used for the DM-RS of the 5G PBCH 416 of the 5G SSB 402 can depend on the PCI value of the 5G cell. In general, a ‘PCI mode 4’ mapping rule can be used to identify the set of resource elements used for the DM-RS of the 5G PBCH 416. To distinguish a 6G cell from a 5G cell, a different PBCH DM-RS resource element mapping rule can be used for 6G than used for 5G. In this manner, a 5G UE 302 can be unable to decode a 6G PBCH 516, and a 6G UE 304 can be unable to decode a 5G PBCH 416. In a first option, a DM-RS of a 6G PBCH 516 apples a resource element mapping rule of ‘(PCI mode 4)+1’. In a second option, a DM-RS of a 6G PBCH 516 apples a resource element mapping rule of ‘(PCI mode 4)+2’. In a third option, a DM-RS of a 6G PBCH 516 apples a resource element mapping rule of ‘(PCI mode 4)+3’.

In a fifth alternative, a 6G PBCH 516 of a 6G SSB 502 can differ from a 5G PBCH 416 of a 5G SSB 402 in one or more aspects based on differences in: i) payload size, ii) CRC length or polynomial, iii) number of resource elements (Res) available for resource mapping (in some cases using identical QPSK modulation), iv) forward error correction (FEC) codes, such as variants of a polar code, and/or v) scrambling techniques. In a sixth alternative, a format of a 6G PBCH 516 of a 6G SSB 502 is the same as a format of a 5G PBCH 416 of a 5G SSB 402 but varies based on one or both of the following options. In a first option, a reserved bit of a 5G PBCH 416 is set to a value when used in a 6G PBCH 516 to indicate that the PBCH is received from a 6G cell. When a reserved bit is set to indicate a 6G cell, additional bits (in some cases excluding cellBarred bits) can be re-interpreted for 6G purposes. In a second option, one or more cellBarred bits of a PBCH can be set to a ‘barred’ value (or another invalid code-point of PBCH content) so that a 5G UE 302 will not use the received PBCH.

In a seventh alternative, non-overlapping synchronization rasters are defined for 6G SSB 502 transmission. A synchronization raster defines a limited set of positions for an SSB that can be sparser than a carrier raster (thereby allowing a UE to perform a cell search more rapidly). In some designs, a frequency offset value Δ may be pre-defined and specified in a 3GPP 6G wireless communication protocol, where a 6G global synchronization channel number (GSCN) for a 6G synchronization raster can be determined using the frequency offset value Δ combined with a GSCN for 5G defined for a 5G synchronization raster, namely, GSCN_{6G}=GSCN_{5G}+Δ. In some embodiments, a non-zero frequency offset value Δ can be specified for each RF band. When the frequency offset value Δ=0, the 6G synchronization raster can be the same as the 5G synchronization raster, in which case to be distinguishable, in some embodiments, the 5G SSB 402 and the 6G SSB 502 can be transmitted in a time-division multiplexed (TDM) manner.

In some designs for a 6G SSB 502, it is possible that a 6G PSS 512 and a 5G PSS 412 and/or a 6G SSS 514 and a 5G SSS 414 have identical signatures. In such scenarios, a 5G UE 302 could locate a 6G PSS 512 and/or a 6G SSS 514 and would need to demodulate the 6G SSB 502 (or portions thereof) to determine whether the 5G UE 302 has received a signal from a 5G cell of a 5G RAN 312 or a signal from a 6G cell of a 6G RAN 314. Similarly a 6G UE 304 could detect the 5G PSS 412 and/or the 5G SSS 414 of a 5G SSB 402 and need to demodulate the 5G SSB 402 (or potions thereof) to determine whether the 6G UE 304 has received a signal from a 5G cell of a 5G RAN 312 or a signal from a 6G cell of a 6G RAN 314. Such detection to an incorrect cell type for the UE would be wasteful. One option to avoid this issue, is to use distinct explicit signatures for the 6G PSS 512 and the 6G SSS 514; however, such an approach can interfere with an additional technique described herein where a 5G SSB 402 (or a portion thereof) can be used as an additional reference signal for measurements by a 6G UE 304 when camped on an MRSS channel. Another option to avoid the cell type issue is to create a frequency raster offset when the PSS and/or SSS of the 5G SSB 402 and the 6G SSB 502 match, thereby requiring a 6G UE 304 to locate 6G SSBs 502 at different positions relative to the 5G SSBs 402. Raster locations for the 6G SSB 502 can be offset from raster locations for the 5G SSB 402. This can prevent a 5G UE 302 from locating a 6G SSB 502, and a 6G UE 304 can avoid locating a 5G SSB 402 unless explicitly searching for it.

FIG. 5B illustrates a diagram 520 of rate matching 5G physical downlink shared channel (PDSCH) and 6G PDSCH transmission around 5G SSBs 402 and 6G SSBs 502. Rate matching provides for determining an amount of data for a channel, e.g., the PDSCH channel, to accord with an amount of radio resources available for transmission for the channel. A 5G PDSCH 522 of a 5G UE 302 can rate match around 5G SSBs 402 and avoid time-frequency resources that are not assigned to the 5G UE 302, e.g., those used by a 6G UE 304. Similarly, a 6G PDSCH 524 can rate match around both 5G SSBs 402 and 6G SSBs 502. In order to rate match properly, the 6G UE 304 can need to know applicable rate matching pattern information for the 5G SSBs 402. In a first alternative, rate matching patterns that indicate time-frequency resources (and possibly periodicities) used by 5G SSBs 402 can be configured and communicated via a radio resource control (RRC) to the 6G UE 304. The first alternative can be applicable when the 5G SSBs 402 are periodic. In a second alternative, rate matching patters indicating the time-frequency resources used by 5G SSBs 402 can be configured via the RRC channel and activated (or deactivated) via downlink control information (DCI) or a medium access control (MAC) control element (MAC-CE). In one example, a rate matching field in a DCI can point to a particular RRC configured rate matching pattern and can indicate whether a scheduled 6G PDSCH 524 will apply the particular RRC configured rate matching pattern. In another example, a bit of the DCI can indicate whether an RRC configured rate matching pattern (corresponding to 5G SSBs 402) is applied to a scheduled 6G PDSCH 524. The RRC configured rate matching pattern can be specific to 5G SSBs 402. The second alternative can be applicable to on-demand 5G SSBs 402. In a third alternative, time-frequency resources of 5G SSBs 402 can be explicitly configured (specified) to 6G UEs 304 so that a 6G UE 304 can know which time-frequency resources of the 5G SSBs 402 to rate match around. In the third alternative (unlike in the first and second alternatives) the time-frequency resources of the 5G SSBs 402 are known to the 6G UE 304, where in the first and second alternatives the time-frequency resources of the 5G SSBs 402 are only implicitly configured via the rate matching patterns.

Rate matching is typically used for data resource elements of the PDSCH; however, other portions of a 6G PDSCH 524, such as the DM-RS, must also avoid the 5G SSBs 402. Two alternatives are proposed for how to handle the DM-RS of the 6G PDSCH 524 when rate matching around the 5G SSBs 402. In a first alternative, the DM-RS of the 6G PDSCH 524 is shifted to the next OFDM symbol that does not collide with the rate matching patterns that indicate time-frequency resources used by 5G SSBs 402. In consideration of processing timelines for a 6G UE 304, the DM-RS may not be shifted to the last OFDM symbol of the 6G PDSCH 524 if the DM-RS is an additional DM-RS in the time domain. In a second alternative, resource block level rate matching is applied for the DM-RS of the 6G PDSCH 524 based on rate matching patterns that indicate time-frequency resources used by 5G SSBs 402.

For a physical downlink control channel (PDCH), a 6G UE 304 can be not expected to decode a 6G PDCCH candidate that collides with rate matching patterns that indicate time-frequency resources used by 5G SSBs 402. A 6G UE 304 can assume that 6G reference signals, such as a 6G SSB 502, a channel-state information (CSI) reference signal (CSI-RS) a sounding reference signal (RSR), etc. do not collide with rate matching patterns that indicate time-frequency resources used by 5G SSBs 402. In some embodiments, for a time-division duplexing (TDD) collision between a 6G uplink (UL) transmission and rate matching patterns indicating time-frequency resources used by 5G SSBs 402, the 6G UL transmission can be dropped.

FIG. 5C illustrates a diagram 540 of different examples of SSBs on different channels in different RF bands. On a 5G channel 542 in a 5G RF band, 5G SSB bursts 404 of 5G SSBs 402 can be configured as normally used by a 5G RAN 312. On a 6G channel 544 in a 6G RF band, 6G SSB bursts of 6G SSBs 502 can have the same structure or a distinct construction from the 5G SSBs 402, as there can be only 6G UEs 304 using the 6G channel 544, and only 5G UEs 302 using the 5G channel 542. On the shared 5G/6G MRSS channel 546, both a 5G SSB 402 and a 6G SSB 502 can be used. In some embodiments, the 6G SSB 502 used on the MRSS channel 546 can differ in construction from the 6G SSB 502 used on the 6G channel 544. There are different options for multiplexing together the 5G SSBs 402 and the 6G SSBs 502 on the MRSS channel 546. In some embodiments, the 5G SSBs 402 and the 6G SSBs 502 are transmitted on the same OFDM symbols (but separable, e.g., at different subcarrier frequencies in a frequency division multiplexing (FDM) mode) to align wake times for a 6G UE 304 to read the 6G SSBs 502 with the 5G SSBs 402. In a first alternative, information of a 6G SSS 514 is used as a reduced complexity 6G SSB 502 for 6G operation on an MRSS channel 546, where the 5G SSB 402 available on the MRSS channel 546 in the same OFDM symbols can be used by the 6G UE 304 for 6G operation. In a second alternative, a 6G SSB 502 used on an MRSS channel 546 for 6G operation differs (e.g., in structure and/or content) from a 6G SSB 502 used on a 6G only channel 544. In some embodiments, network configuration of 6G SSBs 502 can account for the structure/content of the 6G SSBs 502 to allow for power optimized behavior for a 6G UE 304. For example, resources assigned for received signal strength indicator (RSSI) reference signal measurements can be leveraged across 5G and 6G to use the same OFDM symbols for both 5G SSBs 402 and 6G SSBs 502 and for the RSSI reference signals. In some embodiments, SSB staggering can be used to avoid persistent interference across neighbor cells. In some embodiments, 3 ms connected mode measurements can be used. In some embodiments, RSSI resources assigned for measurement can be positioned close resources used for the SSBs.

For a 5G/6G MRSS carrier, a 5G RAN 312 can be substantially co-located with a 6G RAN 314 to allow for coordination to effect dynamic spectrum sharing between the 5G RAN 312 and the 6G RAN 314. 5G cells of the 5G RAN 312 and 6G cells of the 6G RAN 314 can be strongly correlated, including for individual beam level measurements. Two types of SSBs can be considered for measurements performed by a 6G UE 304. A first type of SSB used by the 6G UE 304 can be designated as a primary SSB and correspond to a 6G SSB 502. A second type of SSB used by the 6G UE 304 can be designated as a secondary SSB and correspond to all or a portion of a previous generation SSB, e.g., a 5G SSB 402. A 6G UE 304 can use the secondary SSB for supplemental measurements in addition to the primary SSB to improve measurement accuracy. In some embodiments, the 6G RAN 314 configures a previous generation SSB, e.g., a 5G SSB 402, or a portion thereof, to be used by a 6G UE 304 for additional reference signal (RS) measurements by the 6G UE 304. The 6G RAN 314 can provide information to the 6G UE 304 to allow the 6G UE 304 to locate and use the secondary SSB (e.g., the 5G SSB 402 or a portion thereof) to perform the additional RS measurements. In a first alternative, a PSS or a SSS of a secondary SSB can be configured as an additional measurement RS for a 6G UE 304. For example, a 5G PSS 412 of a 5G SSB 402 or a 5G SSS 414 of a 5G SSB 402 can be configured as the additional measurement RS for the 6G UE 304. In a second alternative, both a PSS and an SSS of a secondary SSB can be configured as an additional measurement RS for a 6G UE 304. For example, a 5G PSS 412 of a 5G SSB 402 and a 5G SSS 414 of a 5G SSB 402 can be configured as the additional measurement RS for the 6G UE 304. In a third alternative, both an SSS and a DM-RS of a PBCH of a secondary SSB can be configured as an additional measurement RS for a 6G UE 304. For example, a 5G SSS 414 and a DM-RS of a 5G PBCH 416 of a 5G SSB 402 can be configured as the additional measurement RS for the 6G UE 304. In a fourth alternative, a PSS, an SSS, and a DM-RS of a PBCH of a secondary SSB can be configured as an additional measurement RS for a 6G UE 304. For example a 5G PSS 412, a 5G SSS 414, and a DM-RS of a 5G PBCH of a 5G SSB 402 can be configured as the additional measurement RS for the 6G UE 304.

FIG. 5D illustrates a flow chart 550 of an example of a secondary SSB being used by a 6G UE 304 for additional RS measurements. At 552, a 6G UE 304 can provide an indication, to a 6G RAN 314 entity, that the 6G UE 304 has a capability to use a secondary SSB as a measurement reference signal (RS). At 554, the 6G RAN 314 entity can signal, to the 6G UE 304, at least one secondary SSB configuration of the MRSS carrier. In some embodiments, the at least one secondary SSB configuration can be included as part of a radio resource management (RRM) or channel-state information (CSI) measurement RS configuration. In some embodiments, a 6G UE 304 can be not required to blindly detect and decode a secondary SSB. In some embodiments, the at least one secondary SSB configuration includes one or more of: i) an applied sequence, ii) a physical cell identity (PCI) value, iii) an SSB index, iv) a time-domain periodicity and offset value, v) a frequency-domain absolute radio frequency channel number (ARFCN) new radio (NR) value, vi) a subcarrier spacing (SCS) value. In some cases, the SCS value may be not required when the same SCS value is used for the co-located 5G and 6G systems. In some embodiments, the secondary SSB configuration includes applied sequences and time-frequency patterns of the secondary SSB, so that the 6G UE 304 need not blindly detect and decode the secondary SSB. In some embodiments, PDSCH transmissions for the 6G UE 304 will be rate matched by the 6G RAN 314 entity around the configured secondary SSB (which can be transmitted by the co-located 5G RAN 312 entity). At 556, the 5G RAN 312 entity broadcasts a legacy 5G SSB 402 via the MRSS carrier. At 558, the 6G UE 304 receives the legacy 5G SSB 402 (or a portion thereof) via the MRSS carrier and performs measurements using the secondary SSB (e.g., a relevant portion of the legacy 5G SSB 402) based on the secondary SSB configuration information obtained from the 6G RAN 314 entity. While the 6G UE 304 can use the secondary SSB for RS measurements, the 6G UE 304 need not be able to decode and comprehend the 5G network information. The secondary SSB is configured for RS measurements (and not for the 5G network purposes). By performing RS measurements with the secondary SSB, the 6G UE 304 can improve measurement accuracy, which can also improve radio resource efficiency and radio resource utilization.

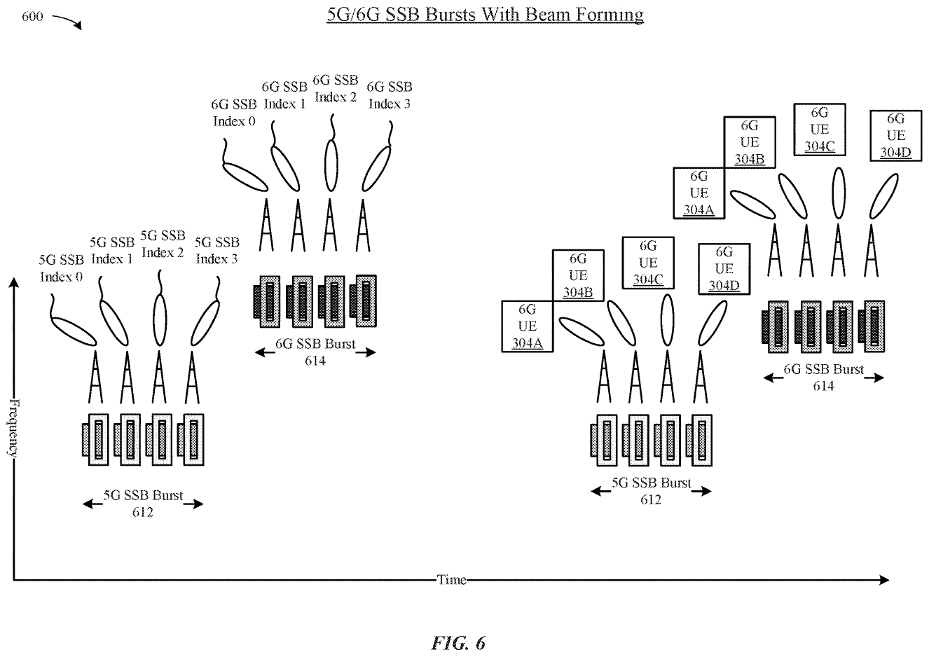

FIG. 6 illustrates a diagram 600 of 5G SSB bursts and 6G SSB burst with beam forming. Providing to a 6G UE 304 configuration information for a secondary SSB (corresponding to a 5G SSB 402 or portion thereof) allows the 6G UE 304 to perform additional reference signal measurements, intended to improve measurement accuracy of a 6G network by the 6G UE 304. The secondary SSB, however, is transmitted by the 5G RAN 312 of the 5G network. To achieve measurement accuracy improvements, a 6G network entity, e.g., the 6G RAN 314, can also configure a quasi-colocation (QCL) source for the secondary SSB, for which configuration information is communicated to the 6G UE 304 by the 6G RAN 314 entity. The QCL source information can allow the 6G UE 304 to know which measurements from a secondary SSB and a primary SSB can be combined (e.g., averaged together) to provide an improved measurement of the 6G network. In some embodiments, a 6G RAN 314 can apply identical or similar beam patterns to 6G SSB 502 transmissions as applied by a co-located 5G RAN 312 to 5G SSB 402 transmissions. For example a 5G SSB burst 612 transmitted by the 5G RAN 312 of the 5G network can use beam-forming transmissions with a particular beam pattern across successive 5G SSBs 402 of the 5G SSB burst 612, while a 6G SSB burst 614 transmitted by the 6G RAN 314 of the 6G network can use beam-forming transmissions with the same particular beam pattern across successive 6G SSBs 502 of the corresponding 6G SSB burst 614. In this manner, a 6G UE 304 can average a reference signal received power (RSRP) measured from a 5G SSB 402, e.g., 5G SSB index 0 of the 5G SSB burst 612, with an RSRP measured from a 6G SSB 502, e.g., 6G SSB index 0 of the 6G SSB burst 614 to provide a more accurate measurement of transmission beams with index value 0. In some embodiments, different 6G UEs 304 can be located at different physical positions to detect transmission beams with different indices to have a strongest RSRP value. A 6G UE 304A can combine (e.g., average) RSRP measurements from 5G SSB index 0 (as a secondary SSB) with RSRP measurements from 6G SSB index 0 (as a primary SSB). Similarly a 6G UE 304B can combine RSRP measurements from 5G SSB index 1 and 6G SSB index 1, a 6G UE 304C can combine RSRP measurements from 5G SSB index 2 and 6G SSB index 2, and a 6G UE 304D can combine RSRP measurements from 5G SSB index 3 and 6G SSB index 3.

In some embodiments, the 6G network entity, e.g., the 6G RAN 314, provides QCL information to indicate to the 6G UE 304 for which 6G SSB 502 (or CSI-RS) the RSRP values can be combined with additional measurements from the secondary SSB, e.g., from the 5G SSB 402 (or portion thereof). In some embodiments, the 6G network entity indicates how to pair index values for a 5G SSB 402 with index values for a 6G SSB 502 to match transmission beams for improved network RS measurements by the 6G UE 304. In some embodiments, a QCL-TypeD indication by the 6G RAN 314 could be used; however, the QCL-TypeD indication may not accurately indicate whether the same or similar transmission beams are used by the 5G RAN 312 as the 6G RAN 314. In some circumstances, the 6G UE 304 can use a wide angle receiving antenna (which could correspond to multiple transmission beams), or the 5G RAN 312 and the 6G RAN 314 could have overlapping transmission beams. To address these ambiguities, the 6G RAN 314 can indicate a QCL source for the 6G UE 304 when a 5G SSB 402 (or portion thereof) is configured as a secondary SSB to the 6G UE 304 to use as an additional 6G measurement RS. The QCL information from the 6G RAN 314 can assist the 6G UE 304 to know which measurements from the secondary SSB can be combined with corresponding measurements from the primary SSB. Given that beam widths used by a 5G RAN 312 and by a 6G RAN 314 can differ, a QCL mapping between the primary SSB and the secondary SSB can be one-to-one, one-to-many, or many-to-one.

5G new radio (NR) wireless communication protocols specify four different types of QCL information that indicate which channel properties measured for one reference signal (RS) from a first transmission beam can be used to improve measurements for a second transmission beam: i) QCL-TypeA: {Doppler shift, Doppler spread, average delay, delay spread}, ii) QCL-TypeB: {Doppler shift, Doppler spread}, iii) QCL-TypeC: {Average delay, Doppler shift}, iv) QCL-TypeD: {Spatial Rx parameter}. Five alternatives are proposed for use by a 6G RAN 314 of a QCL-type to specify a QCL source for a 6G UE 304. In a first alternative, an existing QCL-TypeD is used and corresponds to a spatial receive (rx) parameter. In a second alternative, a new QCL-TypeE is used and corresponds to same, similar, or highly correlated transmit (tx) beam RSRPs. When two antenna ports are specified to be of a QCL-TypeE, the 6G UE 304 can determine a measurement, e.g., an RSRP, of a first antenna port and apply results of the first antenna port to both the first antenna port and to a second antenna port.. In a third alternative, a new QCL-TypeF is used where QCL-TypeF relates to: {Doppler shift, Doppler spread, average gain, average delay, delay spread, spatial Rx parameters (when applicable)}. A primary SSB and a secondary SSB with a same SSB index can be quasi-collocated with QCL-TypeF without explicit signaling. In a fourth alternative, a new QCL-TypeF is used where QCL-TypeF also relates to: {Doppler shift, Doppler spread, average gain, average delay, delay spread, spatial Rx parameters (when applicable)}. In the fourth alternative, a first SSB index of a primary SSB and a second SSB index of a secondary SSB can be signaled with respect to QCL type (e.g. QCL-TypeF). In a fifth alternative, a QCL type can be defined for each 6G (new) SSB index. The QCL information can be signaled per SSB index, e.g., SSB index value ‘X’ of the primary SSB and SSB index ‘Y’ of the secondary SSB are associated with QCL-TypeA and QCL-TypeD. For example, a QCL-Type1 for a first SSB index of a primary SSB=QCL-TypeA, and QCL-Type2 =QCL-TypeD with a second SSB index of a secondary SSB. For another example a QCL-Type1 for a first SSB index of a primary SSB=QCL-TypeC and QCL-Type2 =None with a second SSB index of a secondary SSB.

In some embodiments, the same antenna port, i.e., the same gNB transmit beam and antenna virtualization, can be assumed to be used for both primary SSB index X (6G RAN 314 transmit beam X) and for secondary SSB index Y (5G RAN 312 transmit beam Y). In some embodiments, the primary SSB and the secondary SSB are close to each other (in time/frequency space), e.g., near each other in the time-domain and using the same frequency. In some embodiments, mappings between primary SSB transmit beam indices and secondary SSB transmit beam indices can be configured via the RRC by the 6G RAN 314 to the 6G UE 304. In some embodiments, X=Y can indicate that the same antenna port can be assumed for the primary SSB transmit beam index ‘X’ and the secondary SSB transmit beam index ‘Y’. The 6G UE 304 can combine measurements from a primary SSB index ‘X’ with a secondary SSB index ‘Y’. In some embodiments, the 6G UE 304 can choose the primary SSB and/or from the secondary SSB for measurement and reporting. In some embodiments, resource elements for DM-RS of a 5G PBCH 416 of a 5G SSB 402 (used as a secondary SSB) and resource elements for a DM-RS of a 6G PBCH 516 of a 6G SSB 502 (used as a primary SSB) can be used together with a 6G SSS 514 for certain measurements, such as for an RSRP value, a reference signal received quality (RSRQ) value, tec. In some embodiments, an identical antenna port is configured for a primary SSB (6G SSB 502) transmit beam index ‘X’ and for a secondary SSB (5G SSB 402) transmit beam index ‘Y’so that measurements from the primary SSB and the secondary SSB can be combined.

In addition to QCL Type information, the 6G RAN 314 can configure an applicable power offset value (or assumed to be the same) between a QCL related primary SSB and secondary SSB to allow for proper combining of measurements. In some embodiments, a secondary SSB configured by a 6G RAN 314 to a 6G UE 304 can be considered as a path loss reference signal and used for: i) derivation of downlink (DL) reception and uplink (UL) transmission timing, ii) radio link failure (RLM), iii) beam failure detection (BRD), and/or iv) candidate beam detection (CBD) or candidate beam failure (CBF). A disadvantage of present 5G cellular wireless communication protocols is a requirement for a 5G UE 302 to detect and decode multiple SSBs under poor channel conditions. This requirement becomes more difficult at higher RF bands, e.g. FR2 and FR3. In some embodiments, it is proposed for a 6G SSB 502 design to use multiple 6G PSS 512 and/or 6G SSS 514 to be placed close to each other (in time-frequency space) so that a 6G UE 304 can achieve time offset (TO) and frequency offset (FO) synchronization more quickly. For a 5G/6G MRSS carrier, a 6G UE 304 can use both a primary SSB (6G SSB 502) and a secondary SSB (5G SSB 402) for quicker TO/FO synchronization without waiting for a repeated primary SSB (e.g., a second 6G SSB 502).

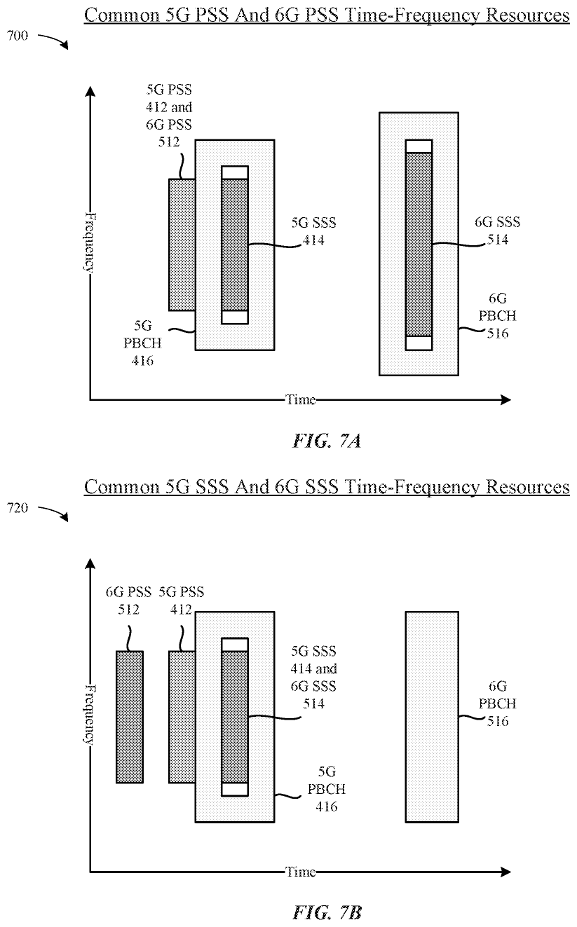

FIGS. 7A and 7B illustrate diagrams 700, 720 of exemplary structures for a 5G SSB 402 and a 6G SSB 502 that share some time-frequency resources on an MRSS carrier. To reduce overhead for MRSS SSB transmissions, some time-frequency resources can be shared between a portion of a 5G SSB 402 and a portion of a 6G SSB 502, i.e., the 5G SSB 402 can the 6G SSB 502 can partially overlap in time-frequency space. In a first option, as illustrated by diagram 700 of FIG. 7A, on an MRSS carrier, a set of common time-frequency resources can be used for both a 5G PSS 412 of a 5G SSB 402 and for a 6G PSS 512 of a 6G SSB 502. The 5G SSB 402 includes, in addition to the 5G PSS 412, a 5G SSS 414, and a 5G PBCH 416, while the 6G SSB 502 includes, in addition to the 6G PSS 512, a 6G SSS 514, and a 6G PBCH 516. In a first alternative, both the 5G PSS 412 and the 6G PSS 512 use the same synchronization sequences. In a second alternative, the 5G PSS 412 and the 6G PSS 512 use different synchronization sequences that have a low cross-correlation with each other. In one option, the 6G PSS 512 is generated with a different sequence type (e.g., generative polynomial) from that used for the 5G PSS 412. In a second option, the 6G PSS 512 applies the same sequence type (e.g., same generative polynomial) as the 5G PSS 412 but with different initialization values. In this manner, different 6G PCI values can be generated.

In a second option, as illustrated by diagram 720 of FIG. 7B, on an MRSS carrier, as set of common time-frequency resources can be used for both a 5G SSS 414 of a 5G SSB 402 and for a 6G SSS 514 of a 6G SSB 502. In a first alternative, both the 5G SSS 414 and the 6G SSS 514 used the same synchronization sequences. In a second alternative, the 5G SSS 414 and the 6G SSS 514 use different synchronization sequences that have a low cross-correlation with each other. In one option, the 6G SSS 514 is generated with a different sequence type (e.g., generative polynomial) from that used for the 5G SSS 414. In a second option, the 6G SSS 514 applies the same sequence type (e.g., same generative polynomial) as the 5G SSS 414 but with different initialization values. In this manner, different 6G PCI values can also be generated.

On an MRSS carrier, when a 5G SSB 402 shares time-frequency resources with a 6G SSB 502, the 5G PBCH 416 of the 5G SSB 402 and the 6G PBCH 516 of the 6G SSB 502 can be mapped to non-overlapping time-frequency resources (as shown in FIGS. 7A and 7B) or to partially overlapping or completely overlapping time-frequency resources (not illustrated). When the 5G PBCH 416 and the 6G PBCH 516 are mapped to non-overlapping time-frequency resources, each of the 5G UE 302 and the 6G UE 304 can locate their corresponding PBCHs without confusion, e.g., via a fixed resource mapping between an synchronization signal, e.g., a PSS or an SSS, of each RAT and the PBCH of the same RAT. When the 5G PBCH 416 and the 6G PBCH 516 are mapped to partially overlapping (or completely overlapping) time-frequency resources, to avoid inter-PBCH interference, the 5G PBCH 416 and the 6G PBCH 516 can use a single set of transmission signals on the overlapping time-frequency resources, i.e., the 5G PBCH 416 and the 6G PBCH 516 can be not multiplexed to the same time-frequency resources. It is proposed herein that a 5G PBCH 416 of a 5G SSB 402 and a 6G PBCH 516 of a 6G SSB 502 on an MRSS carrier should have the same transmission signals on overlapped time-frequency resources, e.g., when 5G PBCH 416 of the 5G SSB 402 and the 6G PBCH 516 of the 6G SSB 502 use identical time-frequency resources, the 5G PBCH 416 and the 6G PBCH 516 should have the same content. Superposition of different PBCH content on the same time-frequency resources should be disallowed to avoid mutual interference.

In some embodiments, a 6G SSB 502 reuses structure and design of a 5G SSB 402 with minor modifications, such as a longer periodicity between SSB bursts, an option to enable/disable SSB transmissions, etc. on a shared 5G/6G MRSS carrier. In some embodiments, a 5G system and a 6G system can share SSBs or a subset of SSBs to reduce MRSS overhead for SSB transmissions. In some embodiments, 6G SSBs 502 are the same, are a subset of, or are a superset of 5G SSBs 402. Sharing SSBs between a 5G system and a 6G system can include the same PSS, SSS, and PBCH are used for both the 5G SSB 402 and the 6G SSB 502. In some cases, the same PCI value and SIB1 value can result from sharing SSBs between the 5G system and the 6G system. While a cell-level configuration in SIB1 can be identical between a 5G system and a 6G system on an MRSS carrier, an enhanced 6G air (radio) interface can be achieved using UE-specific configurations. After an RRC connection is established between a 6G UE 304 and a 6G RAN 314, the 6G UE 304 can received via a 6G air (radio) interface a UE-specific configuration for 6G operation.

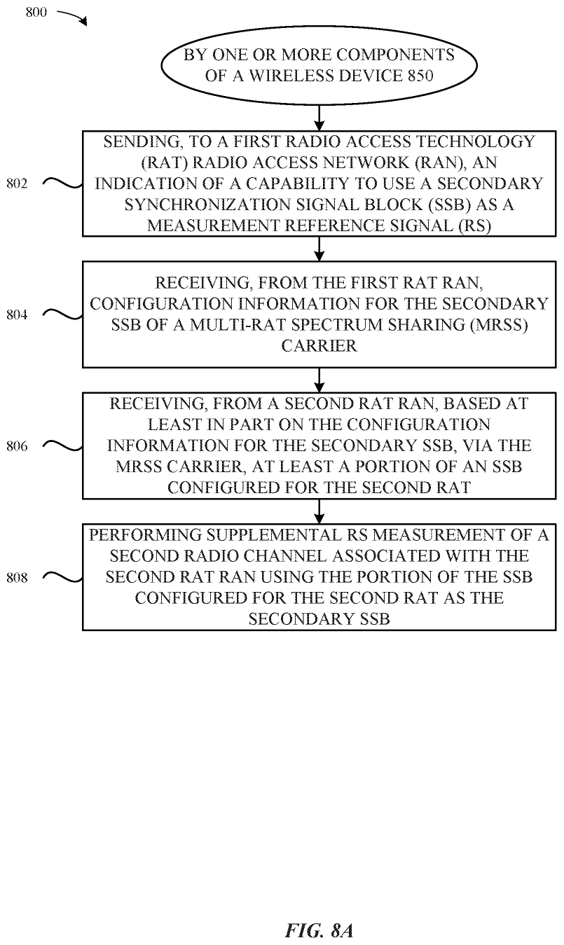

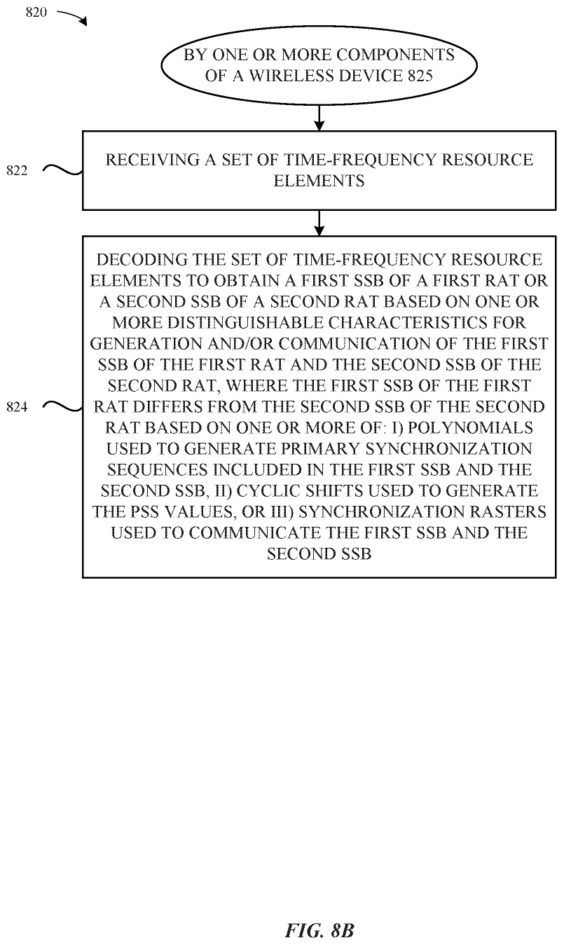

FIG. 8A illustrates a flow chart 800 of an exemplary method to use a secondary SSB, e.g., based on an SSB configured for a second radio access technology (RAT), for supplemental measurement by one or more components of a wireless device, 850. At 802, the method includes sending, to a first RAT RAN, an indication of a capability to use a secondary SSB as a measurement reference signal (RS). At 804, the method includes receiving, from the first RAT RAN, configuration information for the secondary SSB of an MRSS carrier. At 806, the method includes receiving, from a second RAT RAN, based at least in part on the configuration information for the secondary SSB, via the MRSS carrier, at least a portion of an SSB configured for the second RAT. At 808, the method includes performing supplemental RS measurement of a radio channel associated with the first RAT RAN using the portion of the SSB configured for the second RAT as the secondary SSB.

In some embodiments, the method further includes the one or more components of the wireless device 850: i) receiving, from the first RAT RAN via the MRSS carrier, an SSB configured for the first RAT as a primary SSB; ii) performing an RS measurement of a first radio channel associated with the first RAT RAN using the primary SSB; and iii) combining the supplemental RS measurement from the secondary SSB with the RS measurement from the primary SSB. In some embodiments, an M-sequence of a first RAT PSS of the primary SSB, configured for the first RAT, differs from a corresponding M-sequence of a second RAT PSS of the secondary SSB, configured for the second RAT. In some embodiments, the M-sequence of the first RAT PSS of the primary SSB, configured for the first RAT, is generated via a different polynomial from a polynomial used to generate the corresponding M-sequence of the second RAT PSS of the secondary SSB, configured for the second RAT. In some embodiments, the M-sequence of the first RAT PSS and the corresponding M-sequence of the second RAT PSS are generated by two distinct polynomials that belong to a preferred pair of M-sequence generator polynomials. In some embodiments, the first RAT PSS of the primary SSB, configured for the first RAT, is generated by the first polynomial x\hat{ }7+x\hat{ }1+1, and the second RAT PSS of the secondary SSB, configured for the second RAT, is generated by the second polynomial x\hat{ }7+x\hat{ }4+1, where the first and second polynomials are a preferred pair of polynomials for generating M-sequences. In some embodiments, the M-sequence of the first RAT PSS of the primary SSB, configured for the first RAT, is generated by a same polynomial used to generate the corresponding M-sequence of the second RAT PSS of the secondary SSB, configured for the second RAT, and the M-sequence of the first RAT PSS of the primary SSB, configured for the first RAT, uses a different cyclic shift value than the corresponding M-sequence of the second RAT PSS of the secondary SSB, configured for the second RAT. In some embodiments, an M-sequence of a first RAT SSS of the primary SSB, configured for the first RAT, differs from a corresponding M-sequence of a second RAT SSS of the secondary SSB, configured for the second RAT. In some embodiments, a format of a first RAT PBCH of the primary SSB, configured for the first RAT, differs from a corresponding format of a corresponding second RAT PBCH of the secondary SSB, configured for the second RAT. In some embodiments, a DM-RS pattern and/or a DM-RS sequence of the primary SSB, configured for the first RAT, differ from a corresponding DM-RS pattern and/or corresponding DM-RS sequence of the secondary SSB, configured for the second RAT. In some embodiments, the first RAT PBCH of the primary SSB, configured for the first RAT, differs from the corresponding second RAT PBCH of the secondary SSB, configured for the second RAT, based on one or more of: a payload size, a cyclic redundancy check (CRC) length or polynomial, a number of resource elements used for resource mapping, a forward error correction (FEC) code, or a scrambling format. In some embodiments, a format of a first RAT PBCH of the primary SSB, configured for the first RAT, is the same as a corresponding format of a second RAT PBCH of the secondary SSB, configured for the second RAT, and a reserved bit of the first RAT PBCH of the primary SSB, configured for the first RAT, is used to indicate transmission by the first RAT RAN. In some embodiments, one or more additional bits of the first RAT PBCH of the primary SSB, configured for the first RAT, indicate information different from the corresponding one or more additional bits of the second RAT PBCH of the secondary SSB, configured for the second RAT. In some embodiments, a format of a first RAT PBCH of the primary SSB, configured for the first RAT, is the same as a corresponding format of a second RAT PBCH of the secondary SSB, configured for the second RAT, and one or more cellBarred bits of the first RAT PBCH of the primary SSB, configured for the first RAT, are set to a ‘barred’ value. In some embodiments, first RAT transmissions of the first RAT RAN use a different synchronization raster from second RAT transmissions of the second RAT RAN. In some embodiments, a first RAT synchronization raster of the first RAT RAN is determined as a non-zero offset value from a second RAT synchronization raster of the second RAT RAN. In some embodiments, the configuration information for the secondary SSB indicates a second RAT PSS of the secondary SSB, configured for the second RAT, is to be used as the secondary SSB for supplemental RS measurement. In some embodiments, the configuration information for the secondary SSB indicates a second RAT SSS of the secondary SSB, configured for the second RAT, is to be used as the secondary SSB for supplemental RS measurement. In some embodiments, the configuration information for the secondary SSB indicates a second RAT SSS and a DM-RS of a second RAT PBCH of the secondary SSB, configured for the second RAT, is to be used as the secondary SSB for supplemental RS measurement. In some embodiments, the configuration information for the secondary SSB indicates a second RAT PSS, a second RAT SSS, and a DM-RS of a second RAT PBCH of the secondary SSB, configured for the second RAT, is to be used as the secondary SSB for supplemental RS measurement. In some embodiments, the configuration information for the secondary SSB includes one or more of: i) an applied sequence, ii) a PCI value, iii) an SSB index value, iv) a time domain periodicity between SSB bursts, v) a time-domain offset value, vi) a frequency-domain absolute radio frequency channel number (ARFCN) new radio (NR) value, or vii) a subcarrier spacing (SCS) value for the secondary SSB, configured for the second RAT. In some embodiments, the configuration information for the secondary SSB includes an indication of a QCL mapping between at least one transmission beam used for the secondary SSB, configured for the second RAT, transmitted by the second RAT RAN and at least one transmission beam of a primary SSB transmitted by the first RAT RAN. In some embodiments, the indication of the QCL mapping comprises index values for the at least one transmission beam used for the secondary SSB, configured for the second RAT, transmitted by the second RAT RAN and corresponding index values for the at least one transmission beam used for the primary SSB transmitted by the first RAT RAN. In some embodiments, the first RAT comprises a sixth generation (6G) RAT, and the second RAT comprises a fifth generation (5G) RAT. In some embodiments, the first RAT comprises a next generation RAT, and the second RAT comprises a previous generation RAT.

FIG. 8B illustrates a flow chart 820 of an exemplary method performed by one or more components of a wireless device 825 to distinguish between SSBs of two different RATs. At 822, the one or more components of the wireless device 825 receive a set of time-frequency resource elements (REs). At 824, the one or more components of the wireless device 825 decode the set of time-frequency REs to obtain a first SSB of a first RAT or a second SSB of a second RAT based on one or more distinguishable characteristic for generation and/or communication of the first SSB of the first RAT and the second SSB of the second RAT, where the first SSB of the first RAT differs from the second SSB of the second RAT based on one or more of: i) polynomials used to generate PSS values included in the respective SSBs, ii) cyclic shifts used to generate the PSS values, or iii) synchronization rasters used to communicate the SSBs.

In some embodiments, a first PSS of the first SSB of the first RAT and a second PSS of the second SSB of the second RAT are generated using a preferred pair of polynomials. In some embodiments, the first PSS of the first SSB of the first RAT and the second PSS of the second SSB of the second RAT are generated using an identical polynomial with different cyclic shifts applied to the PSSs of the SSBs of each RAT. In some embodiments, the synchronization rasters for the first SSB of the first RAT and the second SSB of the second RAT are non-overlapping and offset by a non-frequency offset value. In some embodiments, the synchronization rasters for the first SSB of the first RAT and the second SSB of the second RAT are transmitted in a time-division multiplexed manner. In some embodiments, the PSS of the first SSB of the first RAT is a first sequence generated by the polynomial x\hat{ }7+x\hat{ }1+1 while the PSS of the second SSB of the second RAT is a second sequence generated by the polynomial x\hat{ }7+x\hat{ }4+1. In some embodiments, the SSBs of the two RATs use different PSSs. In some embodiments, the SSBs of the two RATs use different SSSs. In some embodiments, the SSBs of the two RATs use different PBCH formats. In some embodiments, the PBCHs of the SSBs of the two RATs use different DMRS patterns and/or different sequences. In some embodiments, the PBCHs of the SSBs of the two RATs different in one or more of: i) payload size, ii) CRC length, iii) CRC polynomial, iv) different number of REs used for resource mapping, v) FEC variants of a polar code, vi) scrambling methods.

### Representative Exemplary Apparatus

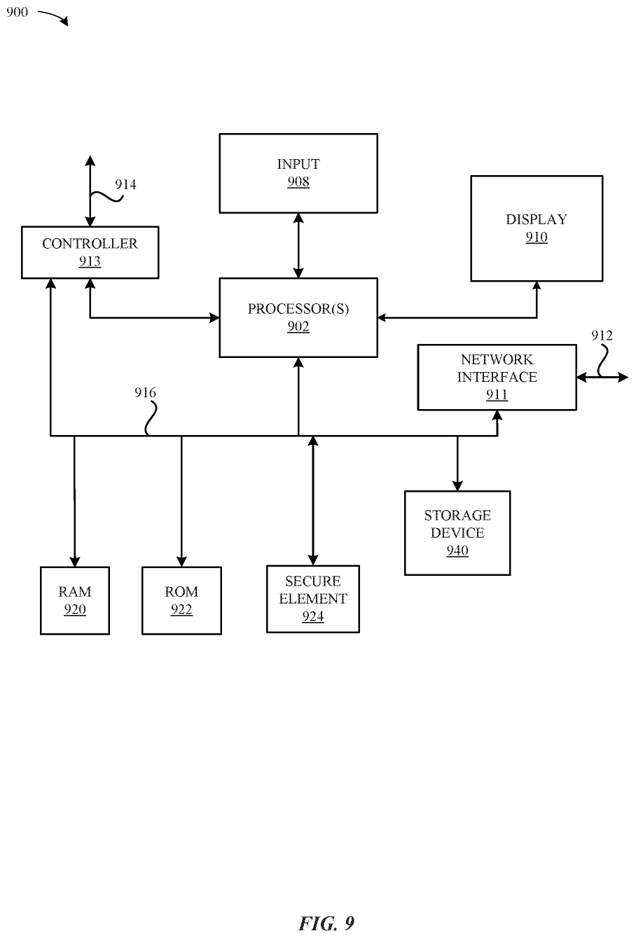

FIG. 9 illustrates in block diagram format an exemplary computing device 900 that can be used to implement the various components and techniques described herein, according to some embodiments. In particular, the detailed view of the exemplary computing device 900 illustrates various components that can be included in a 5G UE 302, a wireless device 102, a 6G UE 304, or a 6G wireless device 850. As shown in FIG. 9, the computing device 900 can include one or more processors 902 that represent microprocessors or controllers for controlling the overall operation of computing device 900. In some embodiments, the computing device 900 can also include a user input device 908 that allows a user of the computing device 900 to interact with the computing device 900. For example, in some embodiments, the user input device 908 can take a variety of forms, such as a button, keypad, dial, touch screen, audio input interface, visual/image capture input interface, input in the form of sensor data, etc. In some embodiments, the computing device 900 can include a display 910 (screen display) that can be controlled by the processor(s) 902 to display information to the user (for example, information relating to incoming, outgoing, or active communication sessions). A data bus 916 can facilitate data transfer between at least a storage device 940, the processor(s) 902, and a controller 913. The controller 913 can be used to interface with and control different equipment through an equipment control bus 914. The computing device 900 can also include a network/bus interface 911 that couples to a data link 912. In the case of a wireless connection, the network/bus interface 911 can include wireless circuitry, such as a wireless transceiver and/or baseband component. The computing device 900 can also include a secure element 924, which can be configured to store one or more SIM profiles and/or eSIM 208 profiles. The secure element 924 can include an eUICC 108, an iUICC, one or more UICCs 118, and/or a component that includes a combination of an eUICC 108 and an embedded SE processor.

The computing device 900 also includes a storage device 940, which can include a single storage or a plurality of storages (e.g., hard drives and/or solid-state drives), and includes a storage management module that manages one or more partitions within the storage device 940. In some embodiments, storage device 940 can include flash memory, semiconductor (solid state) memory or the like. The computing device 900 can also include a Random-Access Memory (RAM) 920 and a Read-Only Memory (ROM) 922. The ROM 922 can store programs, utilities or processes to be executed in a non-volatile manner. The RAM 920 can provide volatile data storage, and stores instructions related to the operation of the computing device 900.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near-field communication (NFC), a cellular wireless network, a fourth generation (4G) LTE, LTE Advanced (LTE-A), 5G, and/or 6G or other present or future developed advanced cellular wireless networks.

The wireless device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode user equipment (UE) can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE network or a 3G legacy network, e.g., an Evolved High Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method to use a secondary synchronization signal block (SSB), the method comprising:
by one or more components of a wireless device:
sending, to a first radio access technology (RAT) radio access network (RAN), an indication of a capability to use the secondary SSB as a measurement reference signal (RS);
receiving, from the first RAT RAN, configuration information for the secondary SSB of a multi-RAT spectrum sharing (MRSS) carrier;
receiving, from a second RAT RAN, based at least in part on the configuration information for the secondary SSB, via the MRSS carrier, at least a portion of an SSB configured for the second RAT; and
performing supplemental RS measurement of a second radio channel associated with the second RAT RAN using the portion of the SSB configured for the second RAT as the secondary SSB.

2. The method of claim 1, further comprising:
receiving, from the first RAT RAN via the MRSS carrier, an SSB configured for the first RAT as a primary SSB;
performing an RS measurement of a first radio channel associated with the first RAT RAN using the primary SSB; and
combining the supplemental RS measurement from the secondary SSB with the RS measurement from the primary SSB.

3. The method of claim 2, wherein an M-sequence of a first RAT primary synchronization signal (PSS) of the primary SSB, configured for the first RAT, differs from a corresponding M-sequence of a second RAT PSS of the secondary SSB, configured for the second RAT.

4. The method of claim 3, wherein the M-sequence of the first RAT PSS of the primary SSB, configured for the first RAT, is generated via a different polynomial than a polynomial used to generate the corresponding M-sequence of the second RAT PSS of the secondary SSB, configured for the second RAT.

5. The method of claim 3, wherein the M-sequence of the first RAT PSS and the corresponding M-sequence of the second RAT PSS are generated by two distinct polynomials that belong to a preferred pair of M-sequence generator polynomials.

6. The method of claim 3, wherein:
the M-sequence of the first RAT PSS of the primary SSB, configured for the first RAT, is generated by a same polynomial used to generate the corresponding M-sequence of the second RAT PSS of the secondary SSB, configured for the second RAT; and
the M-sequence of the first RAT PSS of the primary SSB, configured for the first RAT uses a different cyclic shift value than the corresponding M-sequence of the second RAT PSS of the secondary SSB, configured for the second RAT.

7. The method of claim 2, wherein an M-sequence of a first RAT secondary synchronization signal (SSS) of the primary SSB, configured for the first RAT, differs from a corresponding M-sequence of a second RAT SSS of the secondary SSB, configured for the second RAT.

8. The method of claim 2, wherein a format of a first RAT physical broadcast channel (PBCH) of the primary SSB, configured for the first RAT, differs from a corresponding format of a second RAT PBCH of the secondary SSB, configured for the second RAT.

9. The method of claim 8, wherein a demodulation reference signal (DM-RS) pattern and/or a DM-RS sequence of the primary SSB, configured for the first RAT, differ from a corresponding DM-RS pattern and/or corresponding DM-RS sequence of the secondary SSB, configured for the second RAT.

10. The method of claim 8, wherein the first RAT PBCH of the primary SSB, configured for the first RAT, differs from the second RAT PBCH of the secondary SSB, configured for the second RAT, based on one or more of: a payload size, a cyclic redundancy check (CRC) length or polynomial, a number of resource elements used for resource mapping, a forward error correction (FEC) code, or a scrambling format.

11. The method of claim 2, wherein:
a format of a first RAT physical broadcast channel (PBCH) of the primary SSB, configured for the first RAT, is the same as a corresponding format of a second RAT PBCH of the secondary SSB, configured for the second RAT; and
a reserved bit of the first RAT PBCH of the primary SSB, configured for the first RAT, is used to indicate transmission by the first RAT RAN.

12. The method of claim 11, wherein one or more additional bits of the first RAT PBCH of the primary SSB, configured for the first RAT, indicate information different from the corresponding one or more additional bits of the second RAT PBCH of the secondary SSB, configured for the second RAT.

13. The method of claim 2, wherein:
a format of a first RAT physical broadcast channel (PBCH) of the primary SSB, configured for the first RAT, is the same as a corresponding format of a second RAT PBCH of the secondary SSB, configured for the second RAT; and
one or more cellBarred bits of the first RAT PBCH of the primary SSB, configured for the first RAT, are set to a ‘barred’ value.

14. A method to distinguish between synchronization signal blocks (SSBs) of two different radio access technologies (RATs), the method comprising:
by one or more components of a wireless device:
receiving a set of time-frequency resource elements (REs); and
decoding the set of time-frequency REs to obtain a first SSB of a first RAT or a second SSB of a second RAT based on one or distinguishable characteristics for generation and/or communication of the first SSB of the first RAT and the second SSB of the second RAT,
wherein the first SSB of the first RAT differs from the second SSB of the second RAT based on one or more of:
polynomials used to generate primary synchronization sequences (PSSs) included in the SSBs,
cyclic shifts used to generate the PSSs, or
synchronization rasters used to communicate the SSBs.

15. The method of claim 14, wherein a first PSS of the first SSB of the first RAT and a second PSS of the second SSB of the second RAT are generated using a preferred pair of polynomials.

16. The method of claim 15, wherein:
the first PSS of the first SSB of the first RAT is generated using a first polynomial comprising x\hat{ }7+x\hat{ }1+1, and
the second PSS of the second SSB of the second RAT is generated using a second polynomial comprising x\hat{ }7+x\hat{ }4+1.

17. The method of claim 14, wherein the PSSs of the first RAT and the second RAT are generated using an identical polynomial with different cyclic shifts applied to the PSSs of each RAT.

18. The method of claim 14, wherein the synchronization rasters for the first SSB of the first RAT and the second SSB of the second RAT are non-overlapping and offset by a non-zero frequency value.

19. The method of claim 14, wherein the synchronization rasters for the first SSB of the first RAT and the second SSB of the second RAT are transmitted in a time-division multiplexed manner.

20. An apparatus comprising one or more processors coupled to a memory storing instructions, the one or more processors configured to:
send, to a first radio access technology (RAT) radio access network (RAN), an indication of a capability to use a secondary synchronization signal block (SSB) as a measurement reference signal (RS);
receive, from the first RAT RAN, configuration information for the secondary SSB of a multi-RAT spectrum sharing (MRSS) carrier;
receive, from a second RAT RAN, based at least in part on the configuration information for the secondary SSB, via the MRSS carrier, at least a portion of an SSB configured for the second RAT; and
perform supplemental RS measurement of a second radio channel associated with the second RAT RAN using the portion of the SSB configured for the second RAT as the secondary SSB.
